(19) United States
(12) Patent Application Publication
(10) Pub. No.: US 2015/0356263 A1
(43) Pub. Date: Dec. 10, 2015

(54) Intelligent Health Home Monitoring System Supporting Congestive Heart Failure Self-Care

(71) Applicants: Samir Chatterjee, Rancho Cucamonga, CA (US); Edward Kuang-Yu Lee, Arcadia, CA (US); Ala Alluhaidan, Claremont, CA (US); Nagla Sulaiman Alnosayan, Claremont, CA (US)

(72) Inventors: Samir Chatterjee, Rancho Cucamonga, CA (US); Edward Kuang-Yu Lee, Arcadia, CA (US); Ala Alluhaidan, Claremont, CA (US); Nagla Sulaiman Alnosayan, Claremont, CA (US)

(21) Appl. No.: 14/735,115

(22) Filed: Jun. 9, 2015

Related U.S. Application Data
(60) Provisional application No. 62/009,621, filed on Jun. 9, 2014.

(51) Int. Cl. G06F 19/00

(52) U.S. Cl. CPC G06F 19/345; G06F 19/3418

(57) ABSTRACT

A telehealth system for monitoring the health of a CHF patient has a communication application operating on an electronic device, in communication with a medical authority, a scale connected to the application and configured to provide weight of the patient, a glucometer connected to the application and configured to provide a glucose measurement of the patient, a blood pressure meter connected to the application and configured to provide a blood pressure measurement of the patient, a database in communication with the application configured to store the weight measurement, glucose measurement and blood pressure measurement data, a rule-based expert system in communication with the monitoring database and with the application, wherein the expert system provides a risk assessment based on the weight, glucose reading and blood pressure of the patient.

### CROSS-REFERENCE TO RELATED APPLICATION

The present application claims priority to U.S. Provisional Patent Application No. 62/009,621 filed on Jun. 9, 2014, entitled “MyHeart: An Intelligent mHealth Home Monitoring System Supporting Congestive Heart Failure Self-Care”, the entire disclosure of which is incorporated by reference herein.

### FIELD

The invention relates to an application for home monitoring of congestive heart failure patients.

### BACKGROUND

Congestive heart failure (CHF) is a chronic condition that is common among individuals older than 65[1]. A report published by the American Heart Association indicated that CHF is the most frequent cause for hospital readmissions such that 21.2% of Medicare patients diagnosed with CHF were readmitted to the hospital within 30 days of discharge and the estimated cost of diagnosis and treatment was 37.2 billion dollars in 2009 [2]. CHF is not curable but evidence shows that the quality of life and life expectancy of patients could be improved if the condition is managed by adhering to medications, monitoring symptoms, and salt intake in diet. Still, individuals with CHF are faced with increasing complexity in self-managing their care in their homes [3].

Prior studies have shown that providing better support for patients in the home could have a dramatic effect on cost and efficacy of healthcare [5, 6]. Recently a few technical systems have been tried to assist CHF patients [12, 13].

The problem is that self-care requires behavior change and support from clinical personnel. In theory, three elements must converge at the same time for a behavior to change [7]. These elements are: 1) motivation; 2) ability; and 3) trigger. According to Fogg's Behavior Model [7], when at least one of those three elements is missing, behavior doesn't change. Typically people have low motivation and a low ability to change. If one's ability is high then change can occur. Similarly if one's motivation factor is high, change can occur. What leads to higher motivation? If the activity is pleasurable instead of painful, if there is hope as opposed to fear, and if doing the activity leads to acceptance as opposed to rejection. Our ability to do something is higher when it takes less time, less effort, and less cost. However, Fogg states that an external “behavior trigger” is required to propel a person to change. We believe “just-in-time” texting can act as effective triggers and our recent work has provided support for this hypothesis [14].

Clinicians are key for providing personalized interventions however the growing number of cases and the limited number of clinicians drives the need to find more effective strategies to support self-care. Home telemonitoring has the potential to improve the outcomes of chronic disease self-management [7, 13]. A huge problem that SACHS Medical center is currently facing is with hospital readmission. About 30% of their CHF patients are readmitted within 30 days while nearly 50% are readmitted after 60 days. We design and build a novel home telemonitoring system, MyHeart, to support CHF self-care.

Therefore, there is a need in the art for home telemonitoring system that facilitates CHF self-care.

### REFERENCES

[1] Masoudi, F., Havranek, E., & Krumholz, H. (2002). The burden of chronic congestive heart failure in older persons: Magnitude and implications for policy and research. Heart Failure Reviews, 7(1), 9-16. doi: 10.1023/A:1013793621248

[2] AHA, Lloyd-Jones, D., Adams, R., Carnethon, M., De Simone, G., Ferguson, T. B., . . . Stroke Statistics Subcommittee. (2009). Heart disease and stroke Statistics-2009 update: A report from the american heart association statistics committee and stroke statistics subcommittee. Circulation, 119(3), e101-e104. doi: 10.1161/CIRCULATIONAHA.108.191261

[3] Center for Disease Control and Prevention. (2012). Heart failure fact sheet. Retrieved from http://www.cdc,gov/dhdsp/data statistics/fact sheets/fs heart failure.htm

[4] Riegel, B., Carlson, B. (2002). Facilitators and barriers to heart failure self-care. Patient Education and Counseling, 46(4), 287-295.

[5] Rockwell, J. M., & Riegel, B. (2001). Predictors of self-care in persons with heart failure. Heart Lung: The Journal of Critical Care, 30(1), 18-25. doi: 10.1067/mh1.2001.112503

[6] Kutzleb, J., & Reiner, D. (2006). The impact of nurse-directed patient education on quality of life and functional capacity in people with heart failure. Journal of the American Academy of Nurse Practitioners, 18(3), 116-123. doi: 10.1111/j.1745-7599.2006.00107.x

[7] Fogg, B. (2009). A behavior model for persuasive design. Proceedings of the 4th International Conference on Persuasive Technology, Claremont, Calif. 40:1-40:7. doi: 10.1145/1541948.1541999

[8] Pare, G., Jaana, M., & Sicotte, C. (2007). Systematic review of home telemonitoring for chronic diseases: The evidence base. Journal of the American Medical Informatics Association, 14(3), 269-277.

[9] http://www.myglucohealthstore.com/ProductDetails.asp?ProductCode=Q%2D2NETKIT2

[10] http://www.highcharts.com

[11] http://www.google.com/analytics/

[12] Ferguson, G., Allen, J., Galescu, L., Quinn, J., & Swift, M. (2009). CARDIAC: An intelligent conversational assistant for chronic heart failure patient health monitoring. AAAI Fall Symposium Series: Virtual Health Care Interaction (VHI 09), Arlington, Va.

[13] Guidi, G., Iadanza, E., Pettenati, M. C., Milli, M., Pavone, F., & Biffi Gentili, G. (2012). Heart failure artificial intelligence-based computer aided diagnosis telecare system. Proceedings of the 10th International Smart Homes and Health Telematics Conference on Impact Ananlysis of Solutions for Chronic Disease Prevention and Management, Artimino, Italy. 278-281. doi: 10.1007/978-3-642-30779-9_{—}44

[14] Samir Chatterjee, Kaushik Dutta, Qi Xie, Jongbok Byun, Akshay Pottathil, and Miles Moore, “Persuasive and Pervasive Sensing: a New Frontier to Monitor, Track and Assist Older Adults Suffering from Type-2 Diabetes”, in Proceedings of IEEE Hawaii International Conference in System Sciences (HICSS-46), Maui, HI, Jan 7-10, 2013.

### SUMMARY

A telehealth system for monitoring the health of a CHF patient has a communication application operating on an electronic device, in communication with a medical authority, a scale connected to the application and configured to provide weight of the patient, a glucometer connected to the application and configured to provide a glucose measurement of the patient, a blood pressure meter connected to the application and configured to provide a blood pressure measurement of the patient, a database in communication with the application configured to store the weight measurement, glucose measurement and blood pressure measurement data, a rule-based expert system in communication with the monitoring database and with the application, wherein the expert system provides a risk assessment based on the weight, glucose reading and blood pressure of the patient.

In an embodiment the communication application is also in communication with a community health worker. The system may have a knowledge base in communication with expert system, wherein the medical authority provides rules to the knowledge base. In an embodiment, the expert system provides analysis to the medical authority. The analysis is provided through a dashboard, wherein the dashboard provides medical history and trends.

The risk assessment comprises a determination of whether a risk parameter is a medium or high risk parameter, an addition of a risk factor to a risk score, a determination of whether the risk score is above a high risk threshold, a determination of whether the risk score is within a medium risk threshold, and a determination of whether the risk score is below a low risk threshold, wherein the expert system sends an alert.

A method for monitoring the health of a CHF patient has the steps of measuring a weight of the patient and communicating the weight to an application on an electronic device, measuring a glucose reading of the patient and communicating the glucose reading to the application on the electronic device, measuring a blood pressure of the patient and communicating the blood pressure reading to the application on the electronic device, the application communicating data comprising the weight, glucose and blood pressure to an expert system, and the expert system providing a risk assessment based on the data.

In an embodiment, the step of measuring the heartrate and communicating a heartrate measurement to the application, and wherein the data further comprises heartrate. The application may communicate the data to a medical authority. The medical authority may provide rules to a knowledge base, and the knowledge base informs the expert system. The expert system may provide analysis to the medical authority.

The medical authority may contact the patient through SMS text. The app may present a dashboard on the application providing a patient history to the patient.

The risk assessment may have the steps of determining if a risk parameter is a medium or high risk parameter, if medium risk, adding a medium risk factor to a risk score, if high risk, adding a high risk factor to the risk score, determining if the risk score is above a high risk threshold, and if so, sending a high risk alert, determining if the risk score is within a medium risk threshold, and if so, sending a medium risk alert, and determining if the risk score is below a low risk threshold, and if so, sending a low risk alert.

### DESCRIPTION OF FIGURES

FIG. 1 is a functional diagram showing the system architecture, according to an embodiment of the present invention;

FIG. 2 is a drawing of some screen shots and devices on which the application may run, according to an embodiment of the present invention;

FIG. 3 is a drawing of the application dashboard, according to an embodiment of the present invention;

FIG. 4 is a functional diagram showing the system architecture, according to an embodiment of the present invention; and

FIG. 5 is a representation of a risk assessment algorithm, according to an embodiment of the present invention.

### DETAILED DESCRIPTION

The present invention is a multifaceted system designed to enhance data flow and communication between CHF patients and healthcare providers through a secure and reliable channel. It is comprised of three major components: 1) a patient facing data collection suite including sensors and a mobile app; 2) a data aggregator with rule based expert system; 3) a healthcare provider's dashboard and data.

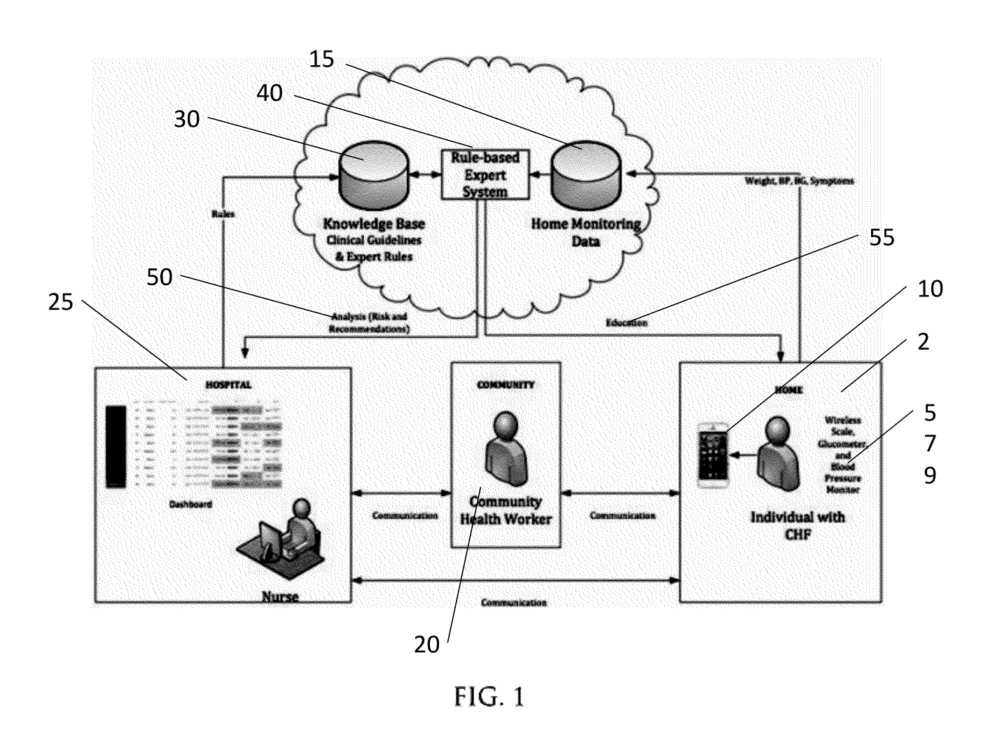

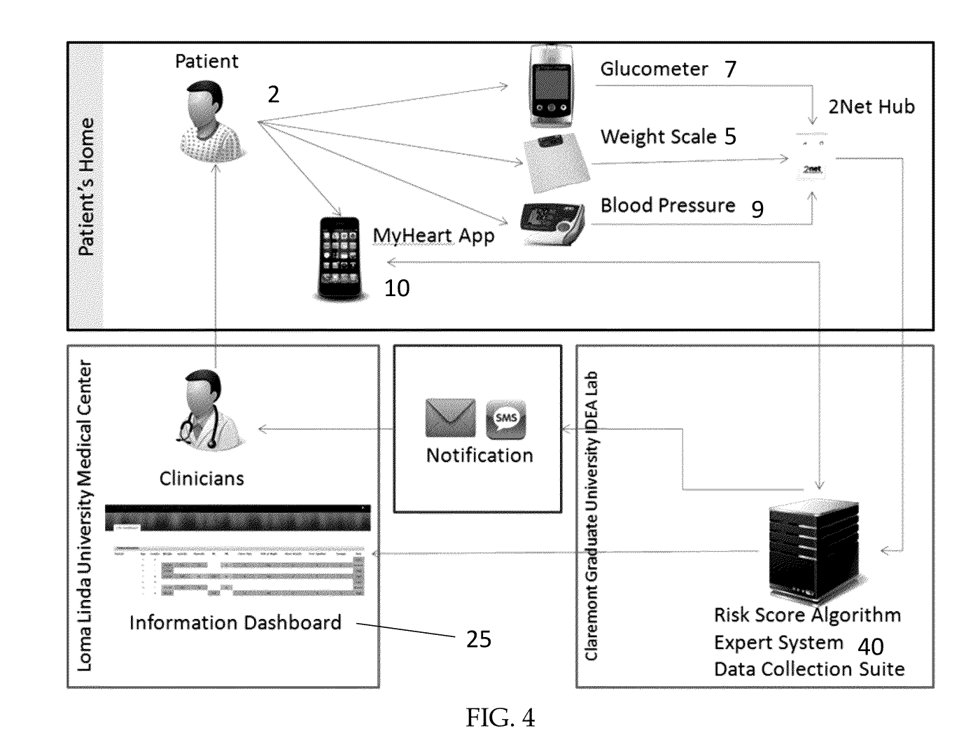

With reference to FIGS. 1 and 4, the individual with CHF 2 may be at home or another location, and is connected to a scale 5, glucometer 7 and blood pressure monitor 9. The scale 5, glucometer 7 and blood pressure meter 9 provide health parameters, respectively weight, blood glucose level and blood pressure, of an individual and are connected to a wireless communication device 10 such as a computer or a smartphone, which runs an application that monitors and records the individual's health parameters. The blood pressure monitor may also provide heartrate, and these are collectively patient data. It is not necessary to use scale 5, glucometer 7 and blood pressure monitor 9 at the same time, but it is preferred. The data is transmitted to the home monitoring data database 15. Health parameter information may also be transmitted to a community health worker 20 or community health command center. Further, the information may be communicated directly by the device 10 to a hospital 25 or from the community health worker 20 to the hospital 25, where a nurse may monitor or assist the individual 2. Information processed by the hospital is transferred to a knowledge base 30 that incorporates clinical guidelines and expert rules. Both the knowledge base 30 and the home monitoring data 15 are in communication with the rule-based expert system 40 with which they share some or all of their data, wherein the expert system produces analysis, including risks and recommendations 50, that is transmitted to the hospital, and education information 55 that is transmitted to the individual 2 through the app on the device 10.

All patient data that flows from the homes to Cloud to the Clinician's dashboard is encrypted as per HIPAA requirements. The following sections describe each component.

With regard to the method of monitoring, the patient facing data collection suite is a set of consumer accessible electronic devices paired with a custom build mobile application to collect patient's vitals and symptoms on a daily basis. Patient's vitals such as blood pressure, weight, and blood glucose are measured using Bluetooth, Wi Fi or ZigBee enabled FDA approved devices which connect via Bluetooth or other wireless connection through a communication hub. Data transmission utilizes cellular technology and is initially collected at a health data repository. Patient's symptoms are collected via a smartphone app (in an embodiment called MyHeart) running on Android OS. Symptom measurements, such as chest pain, shortness of breath, swollen feet etc., are collected and stored in local database at the IDEA Lab at Claremont Graduate University. Each of these parameters are provided by patients using a sliding scale from 0-10 on the app itself. Data communication is established once the mobile application authenticates itself via web services API. Additional functionalities such as measurements display, trending, messaging, and notification are also available for the patient via the mobile application.

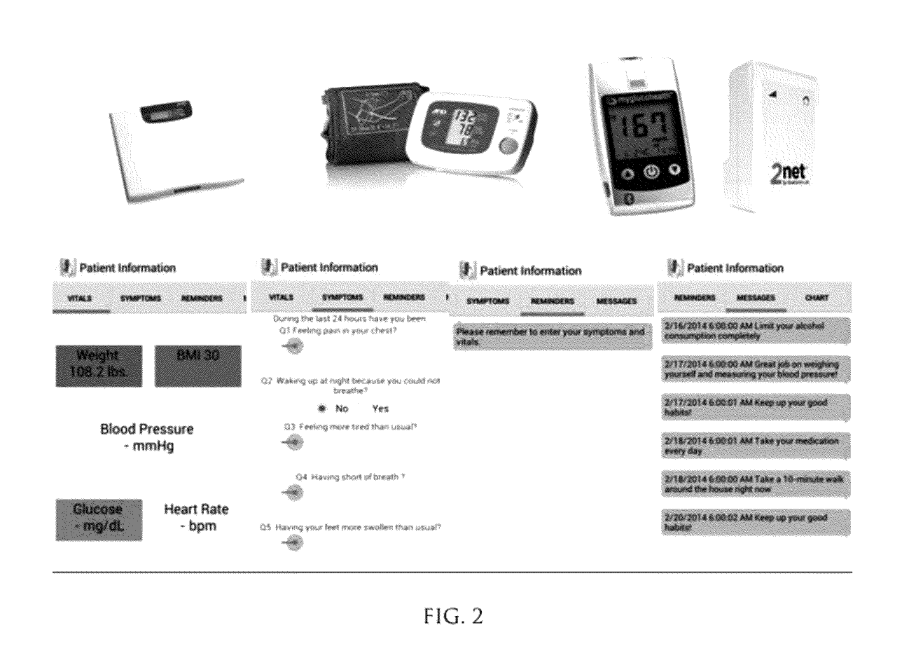

FIG. 2 shows the sensors, such as a scale 5, glucometer 7 blood pressure monitor 9 and mobile application screen shots. The application is designed to collect symptoms and display vitals and messages to encourage self-care behaviors. In a first screen 75 the health parameters are collected within the device through the app. In screen 80, a questionnaire is used to further determine the symptoms, such as “feeling chest pain in last 24 hrs?” or “feeling more tired than usual?” In screen 85, the app reminds the individual to input the data on his or her condition. In screen 90, behavior change messages are provided to encourage healthy behaviors. Example behavior change message would be “Great job for getting your weight under 215 lbs”, “Take your medication every day” or “God loves you”.

### Rule Based Expert System

The rule-based expert system 40 sits in the cloud (See FIG. 1) processes daily incoming data points (i.e., weight, blood pressure, blood glucose, and symptoms) and calculates a risk score. This risk score is used to help inform healthcare providers 20, 25 of any possible relapse of a given patient on a daily basis. In addition, the risk score also triggers urgent notifications to both healthcare providers 20, 25 about the patient's current health status.

TABLE 1
Expert System Data Ranges for Rules Creation (based on input from
Cardiac Nurse)

| | | | | High | High |
|---|---|---|---|---|---|
| | | Medium | Medium | Risk- | Risk- |
| | | Risk-Below | Risk-Above | Below | Above |
| | Normal | Average | Average | Average | Average |
| Heart Rate | 60-79 | 50-59 | 80-99 | =<49 | >=100 |
| Systolic | 90-129 | 80-89 | 130-139 | =<79 | >=140 |
| BP | | | | | |
| Diastolic | 60-79 | 50-59 | 80-89 | <=49 | >=90 |
| BP | | | | | |
| Weight | +/−1 pound | −1.5 # | +1.5 # | −2 # | +2 # |
| Blood | 60-200 | <60 and >50 | >200 and | <50 | >250 |
| Glucose | | | <240 | | |

The rule-based expert system is designed to be flexible and scalable. The rules in Table 1 summarize the assessment a human nurse would conclude on when she sees the health data.

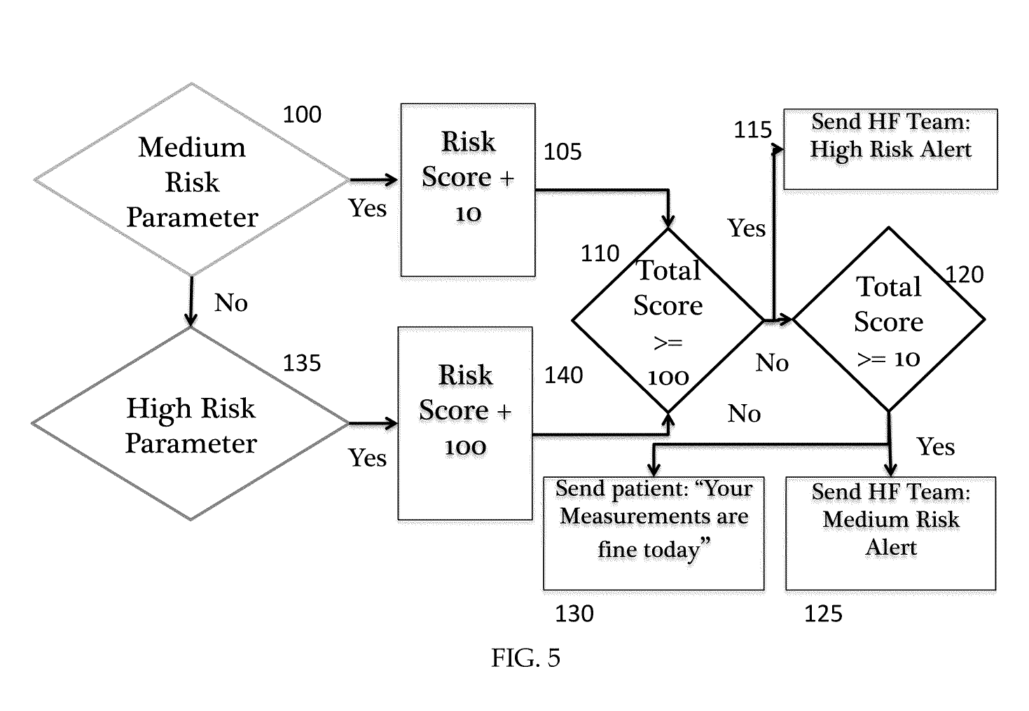

With reference to FIG. 5, an example risk assessment algorithm is shown. At step 100, the parameter is assessed for medium risk. If medium risk, at step 105, a medium risk factor such as 10 is added to the risk score. At step 110, the total score is compared with 100, and if greater than a high risk threshold such as 100, at step 115 a high risk alert is sent. If the total is not greater than 100, then it is compared with 10 at step 120. If greater than 10, or within a medium risk range or threshold, a medium risk alert is sent at step 125, otherwise the value is below a low risk threshold and a message that the patient is fine is sent at step 130. If the parameter is not medium risk, it is assessed for high risk at step 135, and if high risk then a high risk factor such as 100 is added to the risk score at step 140. At step 110 the total score is compared to 100.

Ancillary to the expert system, is the notification system. The notification system utilizes email and SMS messages to send important messages to the heart failure nurses 20, 25, and Cloud Messaging to communicate with patients via the mobile application, for example.

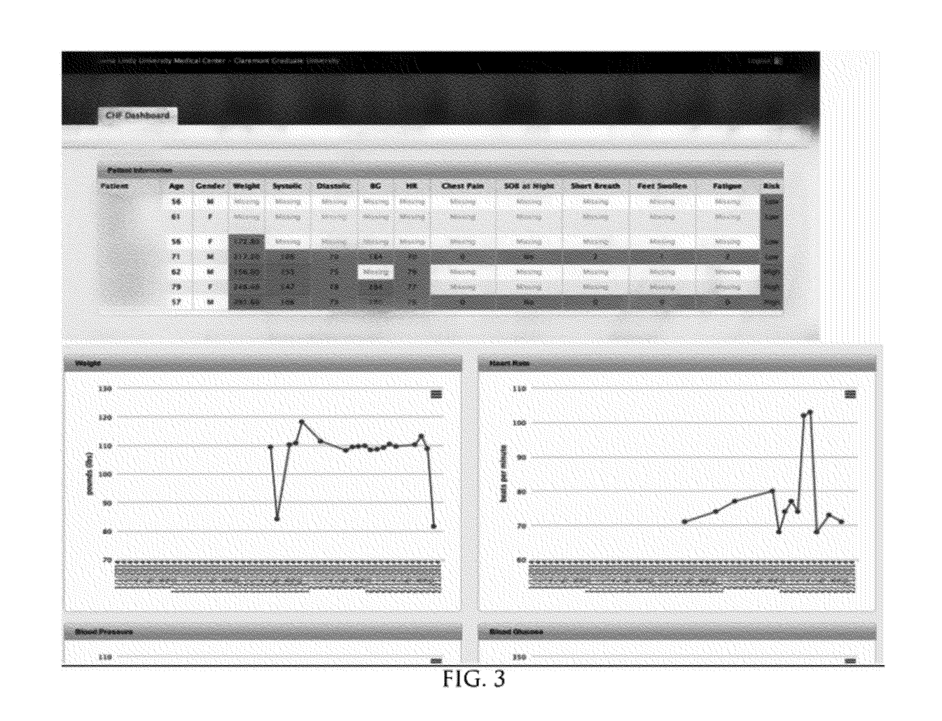

With reference to FIG. 3, the information dashboard is shown. This dashboard is designed to display information that is collected daily from the patient collection suite. Each data point is analyzed by the rule engine and transformed for display. The information dashboard is presented in a tabular format with color indicators to highlight noteworthy data points. In addition, historical trending is accessible with drill down functionality.

Because of the sensitive nature of the data, security measurements are implemented at data collection, transfer, transformation, and display. At data collection point, a unique key is generated at the patient's mobile application side. In conjunction with the patient's phone number, the unique identifier is transferred to the central database every time the patient's phone communicates with the database. Data collection between the app and the database is established based on an automated scheduled method that runs daily. Security for the app is developed at the vendor's location.

All data are collected and stored on a server with authentication. Two different design philosophies drive the database design. First, patient and rule based metadata are stored with traditional transactional normalized design for scalability. With this approach, additional patients can be quickly added without overall impact to the system. Second, all reporting and information displays, such as the information dashboard, utilize a data mart design philosophy for speed and security purposes. Although a data mart design forces data transformation between raw data and final display, the data mart design presents two additional benefits, data traceability and data security.

The telehealth system for heart failure self-care aims to: 1) overcome the gap that occurs when patients transition from the hospital to home environment, and 2) reduce readmissions. The system builds on the behavior model such that it sends messages to patients that potentially trigger behavior change. It also facilitates daily communication among patients and heart failure clinicians so any deterioration in health could be identified immediately. Initial results show that the clinicians and patients are using the system and that some features of the system have been helpful while others need improvement. Future work will focus on incorporating feedback from the patients into the design of the system.

1. A telehealth system for monitoring the health of a CHF patient, comprising:
a) a communication application operating on an electronic device, in communication with a medical authority;
b) a scale connected to the application and configured to provide weight of the patient;
c) a glucometer connected to the application and configured to provide a glucose measurement of the patient;
d) a blood pressure meter connected to the application and configured to provide a blood pressure measurement of the patient;
e) a database in communication with the application configured to store the weight measurement, glucose measurement and blood pressure measurement data; and
f) a rule-based expert system in communication with the monitoring database and with the application
wherein the expert system provides a risk assessment based on the weight, glucose reading and blood pressure of the patient.

2. The system of claim 1, wherein the communication application is also in communication with a community health worker.

3. The system of claim 1, further comprising a knowledge base in communication with expert system, wherein the medical authority provides rules to the knowledge base.

4. The system of claim 1, wherein the expert system provides analysis to the medical authority.

5. The system of claim 4, wherein the analysis is provided through a dashboard, wherein the dashboard provides medical history and trends.

6. The system of claim 1 wherein the risk assessment comprises:
a) a determination of whether a risk parameter is a medium or high risk parameter;
b) an addition of a risk factor to a risk score;
c) a determination of whether the risk score is above a high risk threshold;
d) a determination of whether the risk score is within a medium risk threshold; and
e) a determination of whether the risk score is below a low risk threshold wherein the expert system sends an alert.

7. A method for monitoring the health of a CHF patient, comprising the steps of:
a) measuring a weight of the patient and communicating the weight to an application on an electronic device;
b) measuring a glucose reading of the patient and communicating the glucose reading to the application on the electronic device;
c) measuring a blood pressure of the patient and communicating the blood pressure reading to the application on the electronic device;
d) the application communicating data comprising the weight, glucose and blood pressure to an expert system; and
e) the expert system providing a risk assessment based on the data.

8. The method of claim 7, further comprising the step of measuring the heartrate and communicating a heartrate measurement to the application, and wherein the data further comprises heartrate.

9. The method of claim 7, wherein the application communicates the data to a medical authority.

10. The method of claim 9, wherein the medical authority provides rules to a knowledge base, and the knowledge base informs the expert system.

11. The method of claim 7, further comprising the step of the expert system providing analysis to the medical authority.

12. The method of claim 11, further comprising the step of the medical authority contacting the patient through SMS text.

13. The method of claim 7, further comprising presenting a dashboard on the application providing a patient history to the patient.

14. The method of claim 7, wherein the risk assessment comprises the steps of:
a) determining if a risk parameter is a medium or high risk parameter;
b) if medium risk, adding a medium risk factor to a risk score;
c) if high risk, adding a high risk factor to the risk score;
d) determining if the risk score is above a high risk threshold, and if so, sending a high risk alert;
e) determining if the risk score is within a medium risk threshold, and if so, sending a medium risk alert; and
f) determining if the risk score is below a low risk threshold, and if so, sending a low risk alert.
